(19) United States
(12) Patent Application Publication
(10) Pub. No.: US 2010/0213761 A1
(43) Pub. Date: Aug. 26, 2010

(54) Field Level Inverter Controller

(75) Inventors: Mark McDonald, Milpitas, CA (US); Jeremy Dittmer, Palo Alto, CA (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/393,009

(22) Filed: Feb. 25, 2009

(51) Int. Cl. H02J 3/38

(52) U.S. Cl. 307/18

(57) ABSTRACT

The present invention is directed to an apparatus and method for improving the power output of a solar energy system. A field level inverter controller is described that may improve the power output of individual solar energy systems in a field of solar energy systems by controlling the inverter voltage applied to strings of solar energy units in a solar energy system connected in parallel to an inverter. An inverter load voltage for an improved power output may be calculated or derived empirically. An algorithm stored in the controller may calculate an improved load voltage for the inverters based on factors such as string geometry, solar movement and shade patterns generated by surrounding structures. Improved power output may be empirically determined by the field level inverter controller when the inverter controller directs an inverter to sweep a range of voltage values until a maximum output is detected.

### RELATED APPLICATIONS

This application is related to McDonald, U.S. patent application Ser. No. 12/392,316, entitled “Field Level Tracker Controller,” (Attorney Docket No. SolfP157/SF-P176) filed on even date herewith and hereby incorporated by reference.

### BACKGROUND OF THE INVENTION

Solar energy systems are used to collect solar radiation and convert it into useable electrical energy. A system typically includes an array of solar energy units mounted to a tracker and connected to a controller that directs the tracker via a drive motor. The solar energy units are combined electrically as an arrangement of strings that are connected to an inverter via a node. A string may be a combination of several solar units connected in series. An inverter may apply a load (voltage) to provide a power output to an electrical system. A single inverter may support multiple strings of solar energy units on a single solar energy system. A solar energy unit may be a concentrating photovoltaic (CPV) solar energy device, which is a device that utilizes one or more optical elements to concentrate incoming light onto a photovoltaic cell. This concentrated light, which may exhibit a power per unit area of 500 or more suns, relies on precise orientation to the sun in order to achieve design performance.

The amount of sunlight received by individual solar energy units affects the energy output of solar energy systems and so individual shaded or inoperative units may negatively impact the output of an entire system. In addition solar energy systems are typically distributed relative to one another to provide a maximum exposure to sunlight while minimizing the shade profile that one array may have on another. This results in a sparse distribution of solar energy systems in a field and consequently a limitation on the power available per unit land area. Distribution may be measured as two-dimensional ground cover density (GCD2D). Improvements are needed in order to provide a denser distribution of solar energy systems to maximize the amount of solar energy collected per land area. Other factors that influence the energy output of solar energy systems include the malfunctioning of individual units on a string. Individual solar energy units in a system may break down or be predictably shaded by neighboring solar energy systems or other structures. The reduced power from an individual solar energy unit or string of units may result in unequal voltage at a given current produced among a set of strings connected to a single inverter. Because inverters operate at specific load values, unequal voltage at a given current from connected strings may reduce the power output of an entire system disproportionally. Consequently, performance in individual solar energy systems in a field may be reduced because of periodic shading or malfunction. The shade patterns of surrounding structures (e.g., wind turbines, buildings and trees) may also impact the maximum possible power output of a field of solar energy systems. Present-day controllers do not control the voltage load of individual inverters.

Thus, there exists a need for improved controllers which enable a denser distribution of solar energy systems and provide dynamic control of individual inverters in order to maximize the power output of a field of solar energy systems.

### SUMMARY OF THE INVENTION

A method and apparatus are described for controlling the load applied by individual inverters in field of solar energy systems. A solar energy system may include a two or more of solar energy units electrically connected to an inverter in an arrangement of two or more strings. A field level inverter controller is described that may control the load applied by one or more individual inverters in a field of solar energy systems. The controller may utilize data related to the electrical arrangement of strings in an individual solar energy system and direct the inverter to apply a load voltage that results in an improved power output for the solar energy system. In one embodiment, the field level controller of this invention may include an algorithm for calculating the expected power output of a solar energy system based on the location and dimensions of the solar energy systems as well as the prevailing solar conditions. In another embodiment of this invention the controller may receive power output levels from individual inverters in order to direct the inverter to a load value that results in an improved power output. The controller may be programmable and include a storage device for running an algorithm that calculates a load value to be applied by an inverter that resulted in an improved power output. The controller may be capable of receiving additional data such as the location and dimensions of neighboring structures. This data along with along with temporal and positional information related to the direction of solar radiation may enable the controller to calculate shade patterns affecting individual solar energy systems. A field level controller of this invention may calculate an improved load voltage for individual inverters in a field. The controller may direct individual inverters to apply a range of load values and fix on a load value that generates a power output corresponding to a global maximum in a power voltage (P-V) curve.

The method for constructing a field level inverter controller includes providing a field of one or more solar energy systems. The systems may include two or more solar energy units electrically connected as strings to an inverter. The method also includes inputting the electrical arrangement of these strings into the controller and placing the controller in communication with the field of inverters. The controller may be located remotely from the field of solar energy systems. The communication between the individual inverters may be directed through a wired connection, or a wireless connection. The field level inverter controller offers the aspect of improving power output for a solar energy system by directing the load applied by an inverter to the string arrangement of solar energy units in the system. An object of the invention is to provide a controller that may direct the load applied by individual inverters in a field of solar energy systems. Other objects and many of the attendant advantages will be readily appreciated as the subject invention becomes better understood by reference to the following detailed description.

### BRIEF DESCRIPTION OF THE FIGURES

FIG. 1 depicts a schematic view of a field of solar energy systems.

FIG. 2 shows a schematic view of a partially shaded array of solar energy devices connected electronically in three parallel strings.

FIG. 3 depicts a graph illustrating the effect of partial shade on three parallel strings of solar energy devices.

FIG. 4 depicts a graph showing peak power outputs for a variety of shade conditions on a set of strings in an array.

FIG. 5 depicts a flow chart for one embodiment of a process followed by a field level inverter controller of this invention when power output is reduced in an individual solar energy system in a field.

### DETAILED DESCRIPTION

The present invention will now be described more fully herein with reference to the accompanying drawings. This invention may be embodied in many different forms and should not be construed as limited to the embodiment set forth herein; rather, these embodiments are provided so that this disclosure will be thorough and complete and will fully convey the scope of the invention to those skilled the art.

A field level inverter controller of this invention may control the load applied by one or more individual inverters in a field of solar energy systems. A solar energy system in a field may include two or more solar energy units combined electrically into two or more strings that are connected to an inverter. Inverters generally operate at specific load values or range of load (voltage) values to generate a maximum power point (MPP) output from a specific current. Unequal current drawn from connected strings may reduce the power output of an entire system disproportionally. In one embodiment of this invention, the controller may utilize data related to the electrical arrangement of strings in individual solar energy systems and direct the inverter to apply a load that results in an improved power output for the solar energy system. In another embodiment of this invention, the controller may receive power output levels from individual inverters and direct the inverter to empirically seek a load value that results in an improved power output.

An inverter may be any device used to combine electricity from groups of strings of solar energy units into a stream of usable electrical energy. The inverter may apply a voltage load to the strings of solar energy units to draw power from the group of strings. The solar energy units connected by strings to an inverter may be positioned in any arrangement in a solar energy system. The solar energy units may be mounted in arrays on a moveable tracker or they may be fixed onto a static structure (i.e., a roof). The solar energy units may be any device used to convert solar radiation into useable electrical energy. In one embodiment of this invention the solar energy units are concentrated photovoltaic devices such as those described in pending U.S. patent application Ser. No. 11/138,666 entitled “Concentrator Solar Photovoltaic Array with Compact Tailored Imaging Power Units”, filed May 26, 2005 and incorporated by reference herein. The solar energy units may be flat panel solar energy devices. A field of solar energy systems may include any number of solar energy systems. A field of solar energy systems may include 1, 2, 10, 50, 100 or more systems.

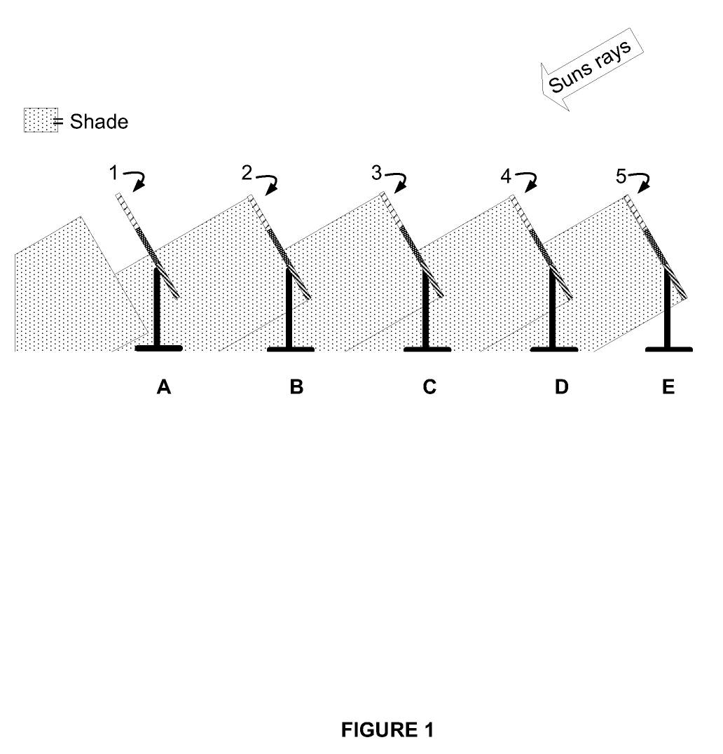

Referring now to FIG. 1, a schematic cross section of a field of five solar energy systems (1-5) is shown facing the direction of the sun's rays. Each of the solar energy systems in this figure includes a tracker (A-E) that is comprised of a single pedestal which contains a single array of solar energy units. The trackers may be fixed or rotate along a path to follow the sun's rays. At certain solar angles, a shadow caused by neighboring solar energy systems may be periodically generated on individual solar energy units in a solar energy system. This may result in the regular reduction of power output from the strings associated with the shaded units. The field level inverter controller of this invention may advantageously minimize the loss of power from individual solar energy systems by controlling the load applied to individual inverters so that an improved load voltage is applied to a solar energy system.

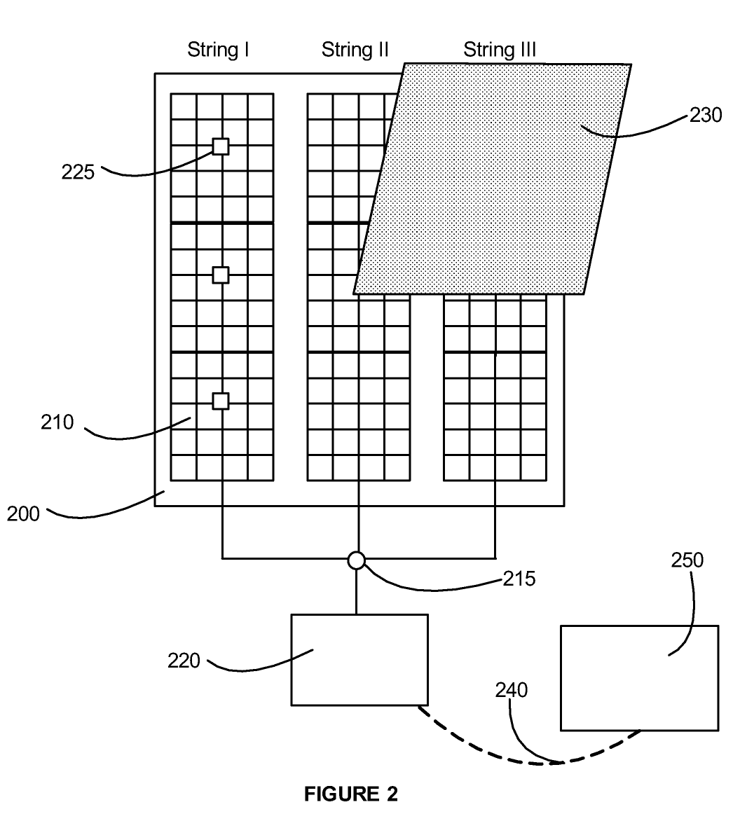

An array 200 shown in a schematic view in FIG. 2, which may represent any of the arrays 1-5 of FIG. 1, includes solar energy units 210 divided into three strings (I-III). This embodiment is understood to be for illustrative purposes only, as the array 200 may include any number of solar energy units arranged in any number of strings. The solar energy units 210 are connected electrically in a string, with the strings I-III connected in parallel via a node 215 to an inverter 220. The strings of solar energy units may contain a plurality of bypass diodes 225, which may limit the loss of power generated by a solar energy system in the event of failure or shading of an individual or group of solar energy units. While a bypass diode may reduce power loss from a string containing a malfunctioning solar energy unit, the string power output may still be affected by a malfunctioning or shaded unit. An example of a shade pattern 230 that may impact the power output of a solar energy system is also shown in FIG. 2. The inverter 220 may draw power from the strings I-III by operating at a specific load value or range of load values. The inverter 220 may dither around a peak range of load values and fix on a maximum power point (MPP). In one embodiment of this invention, the field level inverter controller 250 is in communication 240 with individual inverters 220 in a field. The communication 240 may be via a wireless network or via an electronic network or any method known in the art for linking communicating components in a system.

It can be seen from the shade pattern in FIG. 2 that individual strings in a solar energy system may be differentially affected by shade patterns from neighboring structures. In the example shown in FIG. 2, no shading is observed on string I, while a small amount of shading occurs on string II, and string III is significantly shaded. Shade patterns such as this may result in unequal voltage at a given current through the different strings which may result in a disproportionate reduction in power output. The orientation and global position of the field of solar energy systems, as well as the time of year may all affect the geometry of a shade pattern projected onto individual solar energy systems. Obstruction of solar radiation to a portion of a string in a solar energy unit may be caused by any number of other sources as well, e.g., dirt, debris, or shade from other structures. A reduction in the maximum power output of an individual solar energy system may also occur because of mechanical or electronic failure of a portion of solar energy units in a string. The effects of shading or mechanical or electrical failure of an individual solar energy unit on the output of the individual and neighboring solar energy systems is strongly dependent on the arrangement and connection of strings in a solar energy system and the load voltage applied by the inverter.

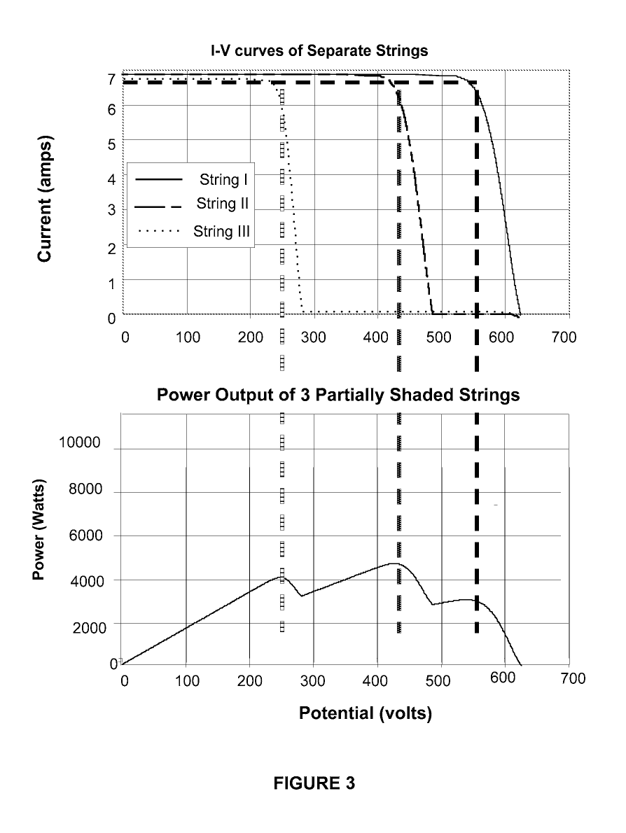

FIG. 3 illustrates how the power output of a solar energy system may be affected for a particular case of partial shading. Also illustrated, is how the voltage load applied by an inverter may mitigate some of the potential power loss caused by partial shading. The top graph shows a simulated current-voltage (I-V) curve of the current flow from the three strings impacted by the shade pattern of FIG. 2. String I is obviously not impacted by the shade and passes 7 amps of current at an inverter load of 550 volts. At that voltage, both strings II and III are not generating any current because of the partial shade on those strings, and so the total power output at that inverter load will be reduced. The impact of this case on the power output may be seen on the simulated power-voltage (P-V) curve shown below in FIG. 3, where the power output generated at an inverter load of 550 volts is represented by a local maximum, but not the global maximum power point (GMPP). At the low end of the I-V curve in the top graph, for example 250 volts, all strings are able to source current, but the full powers of strings II and I are not utilized. This is also illustrated in the lower graph, where at an inverter load of 250 volts, a local maximum is observed, but the GMPP output is also not realized. The GMPP for the shading case shown in FIG. 2 is achieved when the inverter load is at an intermediate voltage of around 440 volts. The field level inverter controller of this invention may direct an individual inverter to an improved voltage load in the case of partial shading of a solar energy system in order to maximize the power output of a solar energy system.

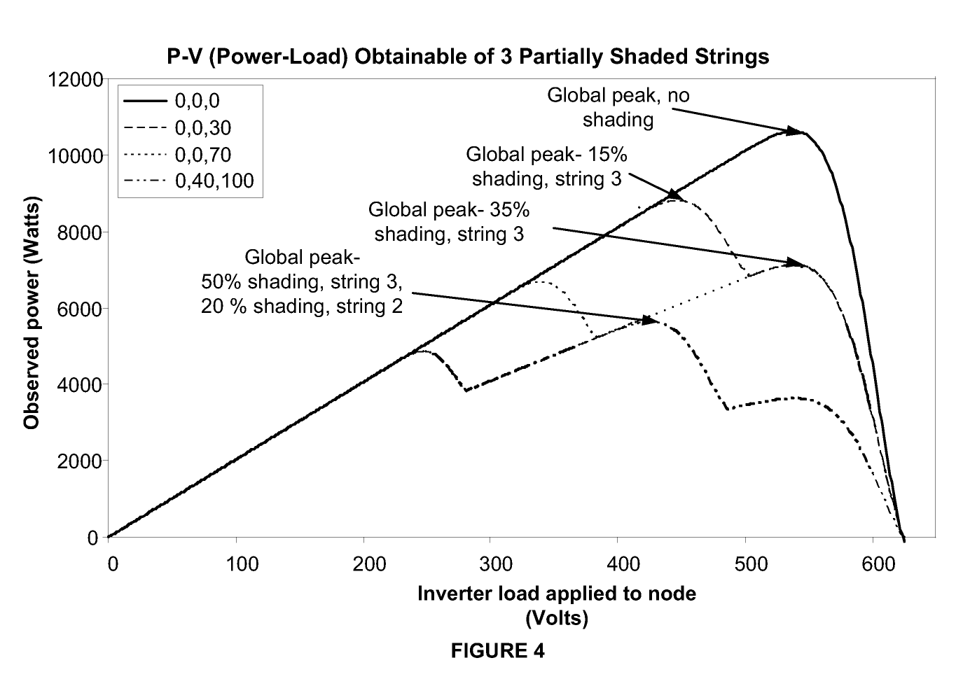

FIG. 4 illustrates how the load applied by an inverter may impact the power output for a range of shade conditions that may affect solar energy systems. Shown in this graph is a simulated of P-V curve for different shading levels on a solar energy system made up of 3 strings of 200 solar energy devices as a function of applied inverter load (volts). The key in the upper left of FIG. 4 indicates how many solar energy units are shaded in each string for each case. It can be seen that as shade differentially covers the strings of solar energy units, a series of peaks form as the inverter may operate at two or more local maxima. A P-V curve generated by a solar energy system may have any number of local maxima limited only by the number of strings connected to a single inverter. As shown in FIG. 4, the global maximum power output may be found at a different applied voltage for the different shade situations.

The present invention may improve the power output of individual solar energy systems in a field of solar energy systems by controlling the inverter voltages applied to strings connected in parallel to the inverters. The value of the inverter load voltage for an improved power output may be calculated or derived empirically. Communication between the field level inverter controller and individual inverters in order to control the inverter load voltage or detect the power output of an individual solar energy system may be by any means known in the art. The field level inverter controller of this invention may be in communication with individual inverters in a field of solar energy systems via any wired connection or via a wireless connection such as a radio or Ethernet connection. In one embodiment the controller, also referred to as a field level inverter controller, may be located locally at the field of solar energy systems. In an alternative embodiment, the field level inverter controller may be located remotely and communicate with the inverter via a wireless (e.g., an internet connection) communication system.

In one embodiment of this invention, the field level inverter controller may direct individual inverters to apply a specific voltage or range of voltages in order to generate an improved power output for an individual solar energy system. The inverter load voltage for improved performance may be determined based upon the cycle of shade patterns impacting a solar energy system. One aspect of this invention is that the reduction of power output due to periodic shading of specific areas of a solar energy device may be mitigated by adjusting the voltage load applied by the inverter in a periodic manner. In one embodiment, the field level inverter controller includes an algorithm used to calculate a daily shade pattern on each solar energy system in a field of solar energy systems. The algorithm may be stored in a storage device (e.g., hard drive, flash memory drive, or other non-volatile devices) in the controller or located separately from the controller. The field level inverter controller may be capable of receiving a variety of data in order to complete these calculations. The calculation may include such factors as the location, dimensions and electronic arrangement of strings in an individual solar energy system, as well as the location and dimensions of nearby structures. The nearby structures may be any structure or landscape element that may generate a shade pattern on a solar energy system in a field (e.g., geographic features, buildings, trees, wind turbines, or neighboring solar energy systems). The structures may be fixed or dynamically track along a path such as a tracking solar energy system or a growing tree. Landscape elements may include mountains or cliffs. The ephemeris equation and precise time may also be used to calculate a shade pattern on a solar energy system. In another embodiment the field level inverter controller of this invention may use a second algorithm to calculate an inverter load based upon an input or calculated shade pattern that results in an improved power output of a solar energy system. The controller may then direct the inverter to the calculated load value. As power reduction from periodic shading is reduced by the use of this invention, denser distribution of solar energy systems is possible, resulting in an increased power output per unit land area. This may beneficially result in higher power output per unit land area as a field of solar energy systems may be spaced with a higher GCR2D distribution in order to generate more power in a fixed area.

In still another embodiment of this invention, the field level inverter controller may direct individual inverters to track though a range of inverter voltages until a GMPP is detected. In one embodiment of this invention, the controller is capable of receiving the individual power output levels for a field of solar energy systems. One aspect of this embodiment may be the detection of any performance-reducing factor such as malfunctioning solar energy units in individual solar energy systems. The reduction of power output caused by malfunctioning units may be mitigated by the use of this invention. In one embodiment the field level inverter controller may detect reduced power from individual solar energy systems by comparing detected power output to an expected power output value for individual solar energy systems. The expected power output value of an individual solar energy system may be calculated or measured. In one embodiment the expected value may be determined by calculating the maximum possible power for a system based on the known efficiency of the solar energy unit. In another embodiment, the expected value may be the power measured at the initialization, or subsequent recalibration, of the solar energy system. The field level inverter controller may receive data from a variety of input means in order to monitor the performance of a solar energy system. Input means may be power monitoring devices (e.g., AC grid intertie, inverter level AC or DC power measurement, string level measurement, or module level measurement), orientation sensing devices for the trackers (e.g., stepper positions, encoders, video devices), health monitoring devices (e.g., inverter current measurement), and weather and solar monitoring devices (e.g., wind speed and direction measurement devices, thermometers, spectrometers, DNI and GNI measurement, sky viewing video devices, etc.). A breakdown in any portion of a solar energy system may affect the power generation of that system as well as the power generation of neighboring systems. These effects may be minimized by the use of the present invention to direct individual inverters to improved load voltages for individual solar energy systems in a field. The improved load value for individual inverters may be empirically determined by monitoring power output as an inverter cycles through a range of load values. In some embodiments the field level inverter controller may include systems to prevent the inverters from cycling through loops of cycling through load values. These safeguards may include a convergence target for terminating power improvements, accompanied by a minimum time before a new attempt, or a minimum time between iterations. In another embodiment of this invention the field level inverter controller may direct an inverter or group of inverters to apply a zero load voltage to a solar energy system or systems in order for maintenance or repairs to occur on those systems. This embodiment advantageously provides a safety feature as inverter voltage may be shut off remotely in an emergency situation.

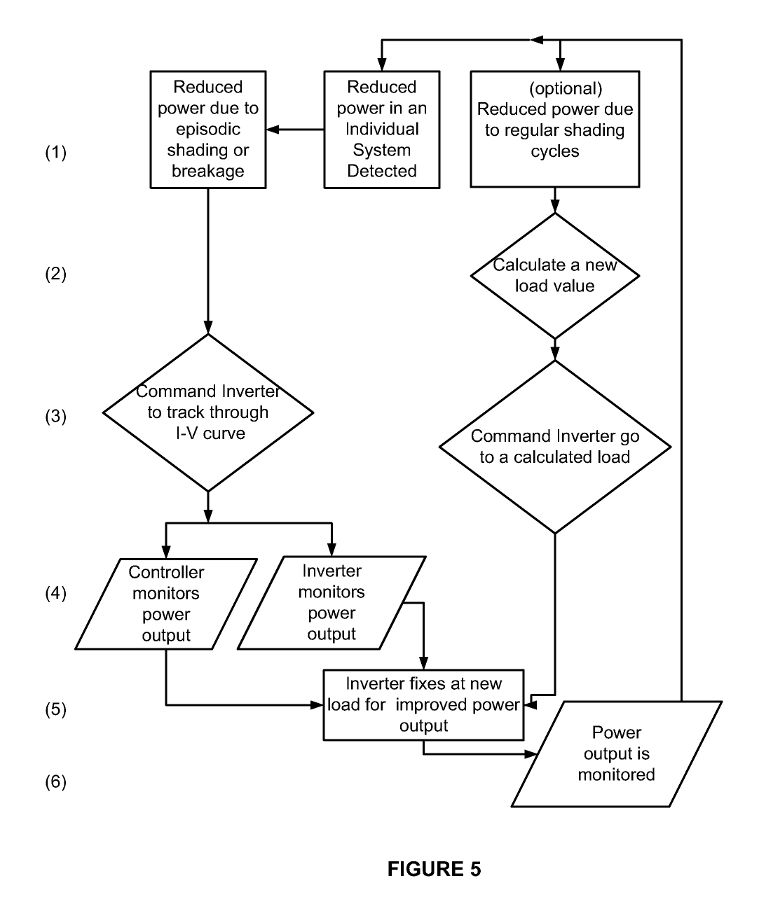

Some embodiments of this invention are shown in the flow chart depicted in FIG. 5 describing how a field level inverter controller may improve the energy output of a solar energy system. Reduced power in an individual solar energy system may be detected or predicted by the field level inverter controller (1). The controller may detect reduced power in an individual system by comparison of the current power output to an expected value for that system or by calculating a shade pattern on a solar energy system based on the locations and dimensions of nearby structures. When reduced power output is due to predicable shading of strings in a solar energy system, the field level inverter controller may then calculate an appropriate inverter load that compensates for shaded solar energy units (2). The calculations to determine shade levels and improved inverter load may occur once during the system set up or occur periodically. Next (3) the field level inverter controller may direct the individual inverter to apply the calculated voltage load. Alternatively, the field level inverter controller may direct the inverter to step through a range of voltages; that is, to perform a P-V curve. When the inverter steps though a range of voltages, the power output may be monitored by the inverter or the controller until a maximum power output is observed (4). The inverter may then fix on a voltage that provides an improved power output for the solar energy system. Whether calculated or derived empirically, the controller may direct the inverter to fix applied voltage load (5). Further, the power output may be continually monitored to insure that deviation from expected output may trigger a resetting of the applied inverter load voltage (6).

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed:

1. A controller system comprising:
a field of one or more solar energy systems, wherein each system comprises:
two or more electrically connected strings of solar energy units, wherein the strings have an electronic arrangement; and
an inverter applying a load to the strings of solar energy units; and
a field level inverter controller in communication with the inverters in the field of solar energy systems, wherein the controller is capable of receiving input of the electronic arrangement of the strings of solar energy units, and wherein the controller controls the loads applied by individual inverters.

2. The controller system of claim 1, wherein the field level inverter controller is capable of receiving power output levels of the individual solar energy systems.

3. The controller system of claim 2, wherein the field level inverter controller further comprises a first algorithm stored in a storage device, and wherein the algorithm calculates an expected power output of the individual solar energy systems.

4. The controller system of claim 1, wherein the field level inverter controller is capable of receiving locations and dimensions of individual solar arrays and nearby structures in the field of solar energy systems, wherein the controller further comprises a second algorithm stored in a storage device, and wherein the second algorithm calculates a shade pattern on individual solar energy systems based on the locations and dimensions of nearby solar arrays and structures.

5. The controller system of claim 4, wherein the second algorithm uses the calculated shade pattern and the electronic arrangement of solar energy units to calculate a load value for individual inverters to provide improved power output of individual solar energy systems.

6. The controller system of claim 4, wherein the nearby structures are selected from the group consisting of solar energy systems, wind turbines, trees, landscape elements, and buildings.

7. The controller system of claim 1, wherein the solar energy units comprise concentrated photovoltaic solar energy units.

8. The controller system of claim 1, wherein the field level inverter controller is located remotely from the field of solar energy systems.

9. The controller system of claim 1, wherein the field level inverter controller is further capable of commanding the inverter to perform a P-V curve.

10. The controller system of claim 9, wherein the inverter is capable of determining a load value that results in an improved power output level from an individual solar energy system.

11. The controller system of claim 9, wherein the field level inverter controller is further capable of commanding individual inverters to determine a load value that results in an improved power output level from an individual solar energy system.

12. A method for constructing a field level controller system comprising:
providing a field of solar energy systems, wherein each system comprises an inverter and two or more electrically connected strings of solar energy units connected to the inverter;
providing a field level inverter controller, wherein the field level inverter controller is capable of receiving input data and storing an algorithm;
inputting an electronic arrangement of the solar energy units into the field level inverter controller; and
placing the field level inverter controller in communication with the individual inverters in the field of solar energy systems, wherein the controller controls a load applied by individual inverters in the field.

13. The method of claim 12, wherein the solar energy systems are concentrated photovoltaic solar energy systems.

14. The method of claim 12, wherein the field level inverter controller is provided at a remote location from the field of solar energy systems.

15. The method of claim 12 wherein the field level inverter controller further comprises a stored algorithm for calculating the load to be applied by individual inverters in a field resulting in an improved output of the individual solar energy systems.

16. The method of claim 12, wherein the load applied is represented by a global maximum on a P-V curve.

17. The method of claim 15, wherein the algorithm further comprises calculating a shade pattern of nearby structures, and wherein the nearby structures are selected from the group consisting of solar energy systems, wind turbines, trees, landscape elements and buildings.

18. The method of claim 12, wherein the input data comprises detected power levels of individual solar energy systems.

19. A method for maximizing the power output of a solar energy system comprising:
providing a solar energy system, wherein the system comprises two or more solar energy units electrically connected by two or more strings, and wherein the strings have an electronic arrangement and are connected to an inverter;
providing a field level inverter controller comprising a storage device;
inputting the level of power output of the solar energy system into the controller;
inputting the electronic arrangement of the solar energy system into the controller;
placing the field level inverter controller in communication with the inverter;
storing an algorithm in the storage device, wherein the algorithm calculates an expected power output of individual solar energy systems;
determining a load for the inverter that provides an improved power output from the solar energy system; and
commanding the inverter to operate under the determined load condition.

20. The method of claim 19, wherein determining a load for the inverter comprises commanding the inverter to step through a range of load values.

21. The method of claim 19, wherein determining a load for the inverter comprises storing an algorithm that calculates an improved load value.
